(19) United States
(12) Patent Application Publication
(10) Pub. No.: US 2025/0142535 A1
(43) Pub. Date: May 1, 2025

(54) RESOURCE IDENTIFICATION METHOD AND RESOURCE IDENTIFICATION APPARATUS FOR CONNECTED CAR SERVICES

(71) Applicant: 42dot Inc., Seoul (KR)

(72) Inventor: Seong Hwan JEONG, Yongin-si (KR)

(21) Appl. No.: 18/933,833

(22) Filed: Oct. 31, 2024

(30) Foreign Application Priority Data
Nov. 1, 2023 (KR) 10-2023-0149002

(51) Int. Cl. H04W 72/02; H04W 4/44

(52) U.S. Cl. CPC H04W 72/02; H04W 4/44

(57) ABSTRACT

Provided are a resource identification method and a resource identification apparatus for connected car services. The method includes receiving resource identifier (ID) data associated with the connected car service and identifying a target resource corresponding to the resource ID data by parsing the received resource ID data, in which the resource ID data includes pieces of information about an ID type, a service to which the target resource belongs, a subject related to the target resource, and a type of the target resource.

### CROSS-REFERENCE TO RELATED APPLICATIONS

This application claims the benefit of Korean Patent Application No. 10-2023-0149002, filed on Nov. 1, 2023, in the Korean Intellectual Property Office, the entire disclosure of which is incorporated herein by reference for all purposes.

### BACKGROUND

### 1. Field of the Invention

One or more embodiments relate to a resource identification method and a resource identification apparatus for a connected car services.

### 2. Description of the Related Art

A connected car service refers to various service techniques that utilize autonomous driving and connectivity of a vehicle, such as a service technique connected to a vehicle, a smart home, and a smart office using an ultra-high-speed mobile communication network such as long-term evolution (LTE) and/or fifth-generation (5G), an autonomous cooperative driving service technique that utilizes vehicle-to-everything (V2X) communication, and a smartphone application that utilizes in-vehicle infotainment. A connected car refers to a vehicle that transmits and receives data inward and/or outward directions of a vehicle with communication applied and provides various and useful values to a driver. Beyond just connectivity, various convenience functions, such as a wireless update, real-time vehicle location sharing, server-based voice recognition, smartwatch linkage, and home-to-car services, are constantly being added to a connected car service.

Furthermore, as an application field of blockchain technology has recently expanded, research on identification and authentication of entities handling information is also actively being conducted. An example is a decentralized identifier (DID) system, which is also referred to as decentralized identification. Unlike an existing identification method, a DID system is not controlled by a central system, and each individual has complete control over their information. A DID system does not require the management of a server to store or authorize data in a central server and to maintain data integrity but processes and stores the data based on a blockchain system.

### SUMMARY

According to an aspect, there is provided a resource identification method for a connected car service, the resource identification method including receiving resource identifier (ID) data associated with the connected car service and identifying a target resource corresponding to the resource ID data by parsing the received resource ID data.

The resource ID data may include pieces of information about an ID type, a service to which the target resource belongs, a subject related to the target resource, and a type of the target resource.

The information about the ID type included in the resource ID data may indicate whether an ID for identifying the target resource is a canonical ID (CID) used in an individual system or a decentralized ID (DID) generated in a decentralized vehicle identity system.

The information about the subject related to the target resource included in the resource ID data may indicate a provider or an owner of the target resource.

The information about the type of the target resource included in the resource ID data may indicate the type of the target resource defined in the service to which the target resource belongs.

The resource ID data may further include information about a model name of the target resource.

The resource ID data may further include information about a version of the target resource.

The resource ID data may further include information about a CID of the target resource.

In the resource ID data, the pieces of information about the ID type, the service to which the target resource belongs, the subject related to the target resource, and the type of the target resource may be distinguished from each other by a delimiter.

The resource ID data may include one or more delimiters located at an end portion of the resource ID data.

According to another aspect, there is provided a resource identification apparatus for a connected car service, the resource identification apparatus including one or more processors and a memory configured to store computer-executable instructions, in which, the computer-executable instructions, when executed by the one or more processors, cause the one or more processors to receive resource ID data associated with the connected car service and identify a target resource corresponding to the resource ID data by parsing the received resource ID data, in which the resource ID data includes pieces of information about an ID type, a service to which the target resource belongs, a subject related to the target resource, and a type of the target resource.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an overview of a connected car system, according to an embodiment;

FIG. 2 is a flowchart illustrating operations of a resource identification method for a connected car service, according to an embodiment;

FIG. 3 is a diagram illustrating a configuration of a resource identification apparatus for a connected car service, according to an embodiment;

FIG. 4 is a diagram illustrating an overview of a decentralized identifier (DID) system, according to an embodiment;

FIG. 5 is a flowchart illustrating operations of a DID management method for a vehicle system, according to an embodiment;

FIG. 6 is a diagram illustrating a provisioning process in a DID system, according to an embodiment;

FIG. 7 is a diagram illustrating a process of issuing a verifiable credential (VC), according to an embodiment;

FIG. 8 is a diagram illustrating an example of authentication of a device management (DM) agent and use of an application programming interface (API), according to an embodiment;

FIG. 9 is a diagram illustrating an application authentication process according to an embodiment; and

FIG. 10 is a diagram illustrating a configuration of a DID management device for a DID system, according to an embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

The same name may be used to describe an element included in the embodiments described above and an element having a common function. Unless otherwise mentioned, the descriptions on the embodiments may be applicable to the following embodiments and thus, duplicated descriptions will be omitted for conciseness.

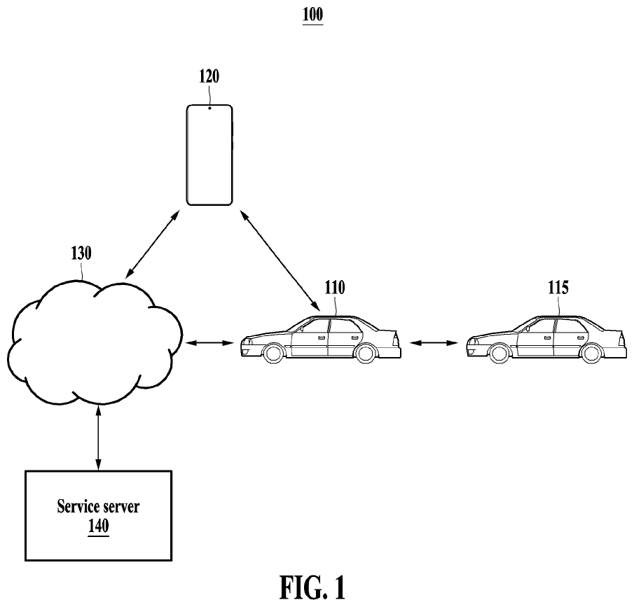

FIG. 1 is a diagram illustrating an overview of a connected car system, according to an embodiment.

Referring to FIG. 1, a connected car system 100 is a system that communicates with other vehicles, traffic infrastructure, communication infrastructure, mobile devices, and the like in real time, helps the convenience and traffic safety of a user (e.g., a driver), and provides various services to the user. The connected car system 100 may provide, to a user in a vehicle, various connected car services that may be provided through an external network by connecting the external network to a vehicle system. The connected car service may include at least one of, for example, an Internet connection, real-time vehicle location detection, communication with other vehicles, remote vehicle control and diagnosis, accident prevention through hazard warning, route guidance, vehicle inspection services, content provision, traffic information provision, autonomous driving, and vehicle-to-everything (V2X) services. The connected car service should not be construed as being limited to the embodiments described above.

The connected car system 100 may include one or more vehicles 110 and 115, a mobile device 120 carried by a user, a communication network 130, and a service server 140 that provides and controls the connected car service. The communication network 130 may be a wireless network.

The vehicle 110 is a vehicle in which a user rides and may include an infotainment system that may provide various services to the user. The vehicle 110 may communicate with the other vehicle 115, the mobile device 120, and/or the service server 140 and may provide the connected car service to the user through the infotainment system. The vehicle 110 may also communicate with the other vehicle 115, the mobile device 120, and/or the service server 140 through the communication network 130.

The mobile device 120 is a device carried by the user that may receive the connected car service and may include various electronic devices such as a smartphone, a notebook computer, a laptop, a personal digital assistant (PDA), a tablet personal computer (PC), a wearable device, and the like. The mobile device 120 may communicate directly with the vehicle 110 in which the user rides or may communicate with the vehicle 110 and/or the service server 140 through the communication network 130.

The service server 140 may provide the connected car service to the user. When a service provision request is received from the vehicle 110 or the mobile device 120, the service server 140 may provide, to the user, the connected car service corresponding to the service provision request. To provide the connected car service, the service server 140 may perform an approval and/or authentication procedure and transmit a variety of data and/or information.

In the case of an existing connected car system, each of identifiers (IDs) for distinguishing a system, a device, and a vehicle is generated as needed. It may be difficult to intuitively identify what resource the generated ID represents, and it may also be impossible to determine whether the generated ID is a canonical ID (CID). An ID system for a connected car system may be needed for cross-reference across each system.

According to an embodiment described herein, a resource identification method, which is a method (or a scheme) of providing (or assigning) a CID that refers to resources (e.g., the vehicle 110, the other vehicle 115, the mobile device 120, and the service server 140) included in the connected car system 100, and a resource identification apparatus are proposed. In the proposed method of providing a CID, an authentication method may be integrated with an authorization method for the resources. Hereinafter, the resource identification method and the resource identification apparatus for the connected car service are described in detail with reference to the accompanying drawings.

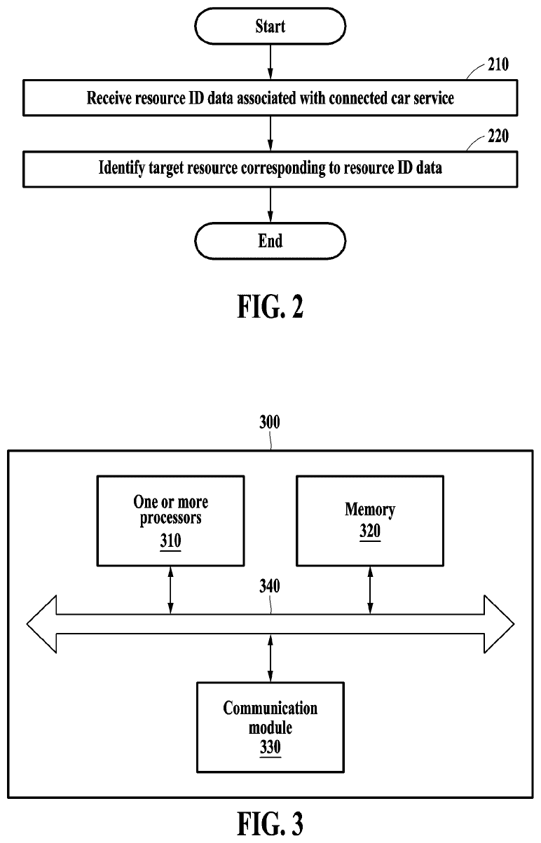

FIG. 2 is a flowchart illustrating operations of a resource identification method for a connected car service, according to an embodiment. In an embodiment, at least one of operations of FIG. 2 may be simultaneously or parallelly performed with one another, and the order of the operations may be changed. In addition, at least one of the operations may be omitted, or another operation may be additionally performed. The operations of the resource identification method may be performed by a resource identification apparatus (e.g., a resource identification apparatus 300 of FIG. 3) described herein.

Referring to FIG. 2, in operation 210, the resource identification apparatus may receive resource ID data associated with a connected car service. The resource ID data may be data that assigns an ID to the resources of the connected car service according to a connected resource name (CRN) scheme to intuitively indicate the ID used in the connected car service. The CRN scheme may enhance security by integrating with a decentralized ID (DID) provided by a decentralized vehicle identity system in addition to assigning the ID to the resources. The CRN scheme may simultaneously satisfy the uniform resource identifier (URI) Internet standard (RFC 3986) and DID W3 standard. The method integrated with the DID is described in detail below.

The resource ID data may include, for example, pieces of information about an ID type, a service to which a target resource belongs, a subject related to the target resource, and a type of the target resource. Here, the target resource may correspond to at least one of a system, a device (e.g., the mobile device 120 of FIG. 1), and a vehicle (e.g., the one or more vehicles 110 and 115 of FIG. 1) related to the connected car service. The system may include a plurality of devices. In an embodiment, the notation of the resource ID data may adopt the notation of the URI defined in RFC 3986.

The information about the ID type included in the resource ID data may indicate whether an ID for identifying the target resource is a CID used in an individual system or a DID generated in the decentralized vehicle identity system. The DID may receive various services, such as device authentication, etc., provided by the decentralized vehicle identity system. The information about the subject related to the target resource included in the resource ID data may indicate a provider or an owner of the target resource. The subject related to the target resource may be, for example, an institution, a company, or an organization.

The information about the type of the target resource included in the resource ID data may indicate the type of the target resource defined in the service to which the target resource belongs. For example, the information about the type of the target resource may include the types of systems and devices. The vehicle may include a set of various controllers, and the ‘device’ may be defined as such an individual controller. The controller may include a controller manufactured by various manufacturers in addition to a controller manufactured by one manufacturer. In general, the unit of the device may not be directly authenticated during communication. The ‘system’ may be defined as a set of various controllers in the vehicle. The system is an entity managed by a device management (DM) part, and devices and applications in the system may be authenticated by the DID assigned to the system. Moreover, the DID system for the software-defined vehicle (SDV) DM and the vehicle may provide flexibility in a system configuration and may be designed to be expandable, thereby providing a method for the device to directly authenticate using the DID. Here, a device ID of the device may be changed to the DID instead of the CID and distinguished.

In an embodiment, the resource ID data may further include information about at least one of a model name of the target resource, a version of the target resource, and a CID of the target resource.

The resource ID data may be notated in the following format, for example.
crn://{id_type}:{service}:{organization}:{resource_type}:{model}:{revision}:{uid}

Here, ‘crn’ may indicate that the resource ID data is according to the CRN scheme described above. ‘id_type’ is an ID type and may indicate whether the ID for identifying the target resource is a CID or a DID. When ‘id_type’ is designated as a CID, the ID for identifying the target resource may be considered as an ID that is independently generated by an individual system. When ‘id_type’ is designated as a DID, the ID for identifying the target resource may be considered as an ID generated by a decentralized vehicle identity system. ‘service’ may indicate a service to which a target resource belongs. ‘organization’ is a subject related to the target resource and may indicate a provider or an owner of the target resource. ‘resource_type’ may indicate the type of the target resource, and the type of the target resource may indicate what kind of resource the target resource is. ‘resource_type’ is defined in the service, and for example, there may be types of systems and devices in DM. In an embodiment, the items of ‘id_type,’ ‘service,’ ‘organization,’ and ‘resource_type’ described above may be essentially included in the resource ID data.

‘model’ may indicate a model (e.g., a car) or the model name of the target resource. When there is no need to distinguish the model or the model name of the target resource, the ‘model’ item may be left blank. ‘revision’ may indicate the version (e.g., a model year) of the target resource. When there is no need to distinguish the version of the target resource, the ‘revision’ item may be left blank. ‘uid’ is a CID of the target resource and may indicate a locally unique ID defined by an organization or a service. The items of ‘model,’ ‘revision,’ and ‘uid’ may be optionally included in the resource ID data.

For example, the following is an example of representing a vehicle controller having a version ‘rev l’ owned by company ‘YY,’ a model name ‘vk0,’ and an ID ‘1005B80E828F31F8’ given by company YY as the resource ID data according to the CRN scheme.
crn://cid:dm:YY:device:vk0:rev1:1005B80E828F31F8

In another example, the following is an example of representing a vehicle controller having a DID generated by a decentralized vehicle identity system as the resource ID data according to the CRN scheme described above.
crn://did:dm:YY:system:vcontroller::AK71005B80E828F31F8

In an embodiment, each item included in the resource ID data may be distinguished from each other by a delimiter. For example, in the resource ID data, the pieces of information about the ID type, the service to which the target resource belongs, the subject related to the target resource, and the type of the target resource may be distinguished from each other by the delimiter. For example, the resource ID data may include one or more delimiters located at the end portion of the resource ID data. The delimiter may have, for example, a symbol form of a colon: but is not limited thereto. In an embodiment, consecutively repeated delimiters may be abbreviated as one and notated. For example, in ‘crn://did:dm:42dot:system:::,’ consecutive delimiters ‘:::’ may be abbreviated, so the resource ID data may be expressed as ‘crn://did:dm:42dot:system:.’ The delimiter located at the end portion of the resource ID data is not omitted in the sense that the delimiter does not refer to a unique certain resource.

In operation 220, the resource identification apparatus may identify the target resource corresponding to the resource ID data by parsing the received resource ID data. The resource identification apparatus may extract, from the resource ID data, the pieces of information about the ID type, the service to which the target resource belongs, the subject related to the target resource, and the type of the target resource. In addition, the resource identification apparatus may further extract, from the resource ID data, the information about at least one of the model name of the target resource, the version of the target resource, and the CID of the target resource. The resource identification apparatus may identify the target resource indicated by the resource ID data, based on the extracted information.

The proposed CRN scheme may provide a method of intuitively identifying resources while providing universal uniqueness for the ID defined in various systems. In addition, the proposed CRN scheme may provide compatibility for using the ID issued in an existing system. For example, in the CRN scheme, an entity identified as a vehicle ID in a vehicle-related service or platform may be expressed as follows using a CID type.

crn://cid:tap:YY:vehicle:adrt::1234
crn://cid:platform:YY:fleet:adrt::{FLEET_ID}

The proposed CRN scheme may provide expandability to identify an entity of other companies or providers. For example, in the CRN scheme, a vehicle manufactured by company YY may be expressed as follows using a CID type.
crn://cid:dm:YY:vehicle:vname:v1:{VIN_NUMBER}

In an embodiment, when an application programming interface (API) is implemented using the CRN scheme, it may be possible to make a request (or query) using the CRN scheme. For example, it may be assumed that there is the following resource ID data defined according to the CRN scheme.

crn://did:dm:YY:system:vcontroller:m123:AK71005B80E828F31F8
In addition, it may be assumed that there is the following API, for
example.
https://api.os.ai/dm/v1/systems/:crn

Requests (or queries) such as the examples described in Table 1 below may be possible in the API.

TABLE 1

| Request according to CRN scheme | Description of the request |
|---|---|
| did:dm:YY:system::: | View all target resources belonging |
| | to the resource type of a system in |
| | YY organization |
| did:dm:YY:system:vcontroller:: | View all target resources identified |
| | by a model vcontroller in the |
| | resource type of a system in YY |
| | organization |
| did:dm:YY:system:vcontroller:m123: | View all target resources identified |
| | by a version m123 of a model |
| | vcontroller in the resource type of |
| | a system in YY organization |

FIG. 3 is a diagram illustrating a configuration of a resource identification apparatus for a connected car service, according to an embodiment.

Referring to FIG. 3, a resource identification apparatus 300 may be an apparatus that analyzes resource ID data for a connected car service described herein and identifies a target resource. The resource identification apparatus 300 may include one or more processors 310, a memory 320, and a communication module 330, and each component of the resource identification apparatus 300 may communicate with each other via a communication bus 340. In an embodiment, some of these components may be omitted from the resource identification apparatus 300, or another component may be added to the resource identification apparatus 300.

The one or more processors 310 may control other components (e.g., hardware or software components) of the resource identification apparatus 300 and may perform a variety of data processing or operations. According to an embodiment, as at least part of data processing or operations, the one or more processors 310 may store instructions or data received from other components in the memory 320, process the instructions or data stored in the memory 320, and store result data in the memory 320.

The one or more processors 310 may include a main processor (e.g., a central processing unit (CPU) or an application processor (AP)) or an auxiliary processor (e.g., a graphics processing unit (GPU), a neural network processing unit (NPU), an image signal processor (ISP), a sensor hub processor, or a communications processor (CP)) that may operate independently or together with the main processor.

The memory 320 may store a variety of data used by the components (e.g., the one or more processors 310 or the communication module 330) of the resource identification apparatus 300. The data may include, for example, a program (e.g., an application), input data or output data for instructions related thereto, and log data of a computing system. The memory 320 may store instructions executable by the one or more processors 310. The memory 320 may include a volatile memory or a non-volatile memory.

The communication module 330 may support the establishment of a direct (e.g., wired) communication channel or a wireless communication channel between the resource identification apparatus 300 and another device and may support the communication through the established communication channel. For example, the communication module 330 may receive the resource ID data generated according to a CRN scheme from a communication network or another device.

The communication module 330 may include a communication circuit to perform a communication function. The communication module 330 may include a CP that operates independently from the one or more processors 310 and supports direct (e.g., wired) or wireless communication. The communication module 330 may include a wireless communication module (e.g., a Bluetooth communication module, a cellular communication module, a wireless fidelity (Wi-Fi) communication module, or a global navigation satellite system (GNSS) communication module) that performs wireless communication or a wired communication module (e.g., a local area network (LAN) communication module).

According to an embodiment, the resource identification apparatus 300 may include the one or more processors 310 and the memory 320 configured to store computer-executable instructions. When the computer-executable instructions are executed by the one or more processors 310, the one or more processors 310 may receive the resource ID data associated with the connected car service. The resource ID data may include pieces of information about an ID type, a service to which the target resource belongs, a subject related to the target resource, and a type of the target resource. The information about the ID type included in the resource ID data may indicate whether an ID for identifying the target resource is a CID used in an individual system or a DID generated in a decentralized vehicle identity system. The information about the subject related to the target resource included in the resource ID data may indicate a provider or an owner of the target resource. The information about the type of the target resource included in the resource ID data may indicate the type of the target resource defined in the service to which the target resource belongs. The resource ID data may further include information about at least one of a model name of the target resource, a version of the target resource, and a CID of the target resource. The one or more processors 310 may identify the target resource corresponding to the resource ID data by parsing the received resource ID data. The one or more processors 310 may extract, from the resource ID data, the pieces of information about the ID type, the service to which the target resource belongs, the subject related to the target resource, and the type of the target resource. In addition, the one or more processors 310 may further extract, from the resource ID data, information about at least one of the model name of the target resource, the version of the target resource, and the CID of the target resource. The one or more processors 310 may identify the target resource indicated by the resource ID data, based on the extracted information.

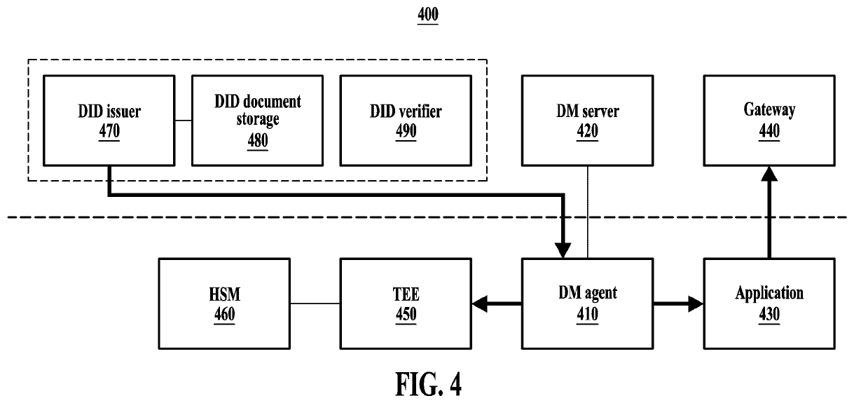

FIG. 4 is a diagram illustrating an overview of a DID system, according to an embodiment.

Referring to FIG. 4, a DID system 400 (hereinafter, also referred to as a decentralized identity verification system) may be a system that authenticates data, when necessary, without undergoing a centralized system, in which an individual entity has sovereignty over the data. The individual entity may verify its identity and qualifications by selecting and providing information according to the purpose. The DID system 400 may provide a method of issuing and verifying a DID. In the present disclosure, the DID system 400 may also be referred to as a ‘decentralized vehicle identity system.’ All systems related to a vehicle may receive a DID through the DID system 400. For the vehicle and a cloud system to form a secure channel with each other, device authentication must proceed through the DID. The DID system 400 may perform, for example, a process of issuing, providing, and authenticating the DID in a vehicle system. The process of issuing, providing, and authenticating the DID using the DID system 400 is described in detail below.

All system IDs of a DM service may be issued by the DID system 400. The DM service may adjust the scope of a DID document assigned to each DID as a controller of the DID document. The DID document may be configured based on information stored in a blockchain as a subject of a JavaScript object notation for linked data (JSON-LD) structure, for example. Due to the persistence and immutability of the blockchain, it may be impossible for anyone other than the owner of the DID to change the content of the DID document. The DID document may include, for example, a list of encrypted public keys, a list of methods in which the DID may be used for authentication, a list of services that may use the DID, and other pieces of expandable information.

In an embodiment, the DM service may have setting information for each system and device and provide a database in the form of a key value for each profile. The DM service may provide, for example, an API for identifying a current system ID, an API for issuing verifiable presentation (VP) data to form a secure channel, or a shared key-value configuration of a provider, a system model, or a dedicated system.

In the resource ID data generated according to the CRN scheme described above, designating the ID type as a DID and may adopt the DID standard developed by the World Wide Web Consortium (W3C). In the DID system 400, the DID may become a means of identifying any entity, and a DID verifier 490 may authenticate the DID. Security-related information, such as the authentication method of the DID or the scope of the DID document, may be recorded through the DID document.

In an embodiment, the DID system 400 may include a DID issuer 470, a DID document storage 480, a DID verifier 490, a DM server 420, a gateway 440, a DM agent 410, a hardware security module (HSM) 460, a trusted execution environment (TEE) 450, and an application 430. The DID issuer 470, the DID document storage 480, the DID verifier 490, the DM server 420, and the gateway 440 may operate in the cloud system. The DID issuer 470, the DID document storage 480, and the DID verifier 490 may operate based on a blockchain system. The DM agent 410, the HSM 460, the TEE 450, and the application 430 may operate in a device (e.g., a vehicle).

A verifiable credential (VC) issued by the DID issuer 470 may be transmitted to the DM agent 410. The VC may include, for example, information about a subject, an issuer, and a claim. The subject may be, for example, a user, a company, an organization, an institution, a thing, or any subject that may be described. The issuer may be, for example, a certain group or individual, such as a company, an organization, a school, a bank, and the like, which stores personal information and additional information and has a function of verifying the authenticity of certain data. The claim may be any expressible sentence, for example, any sentence that describes a situation. The DID document storage 480 may store the DID document including the DID and information related to the DID. The DID verifier 490 may receive one or more VCs and perform verification thereon.

The DM agent 410 may transmit the VP data to the application 430. The DM agent 410 may mutually authenticate with the DM server 420 that monitors and controls a DM service function through an encryption protocol of mutual transport layer security (mTLS). The mTLS may verify whether both entities at both ends of a network connection have a correct private key.

The gateway 440 is a kind of entry tool located in the cloud system and may identify and authenticate a vehicle using the VP data and the DID verifier 490. The gateway 440 may perform routing on the authenticated traffic to an appropriate location. For example, the gateway 440 may receive a request for verification of the VP data from the application 430 and may transmit the received VP data to the DID verifier 490. The gateway 440 and the application 430 may be connected to each other through a TLS security protocol.

The TEE 450 is a secure area of a main processor and may ensure that code and data loaded inside the TEE 450 are protected in terms of confidentiality and integrity. The HSM 460 may store the data transmitted from the TEE 450. For example, the HSM 460 may store data about a primary credential.

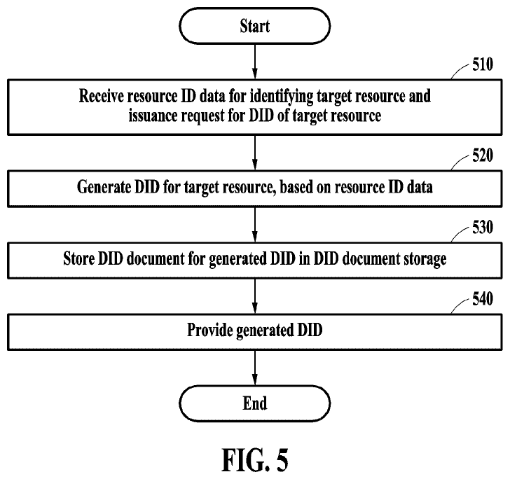

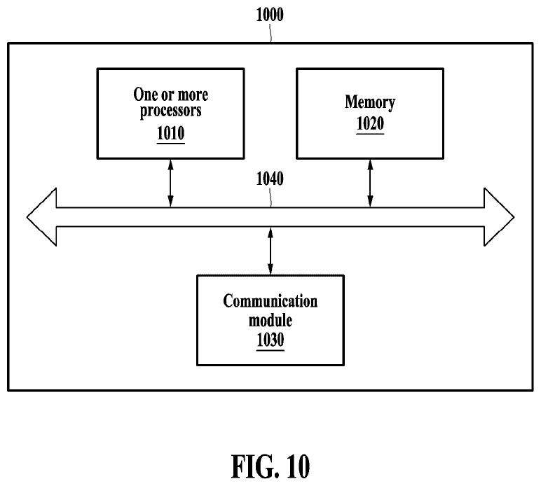

FIG. 5 is a flowchart illustrating operations of a DID management method for a vehicle system, according to an embodiment. The DID management method may be operated based on the DID system 400 described with reference to FIG. 4. At least one of operations of FIG. 5 may be simultaneously or parallelly performed with one another, and the order of the operations may be changed. In addition, at least one of the operations may be omitted, or another operation may be additionally performed. The operations of the DID management method may be performed by a DID management device described herein (e.g., a DID management device 1000 of FIG. 10).

Referring to FIG. 5, in operation 510, the DID management device may receive, from a provider device, resource ID data for identifying a target resource in a vehicle system and an issuance request for a DID of the target resource. A provider may generally refer to a device registration performer who initiates a provisioning process of registering a device and actively proceeds with a task. For example, the provider may be responsible for the final quality evaluation of a vehicle or responsible for shipping a vehicle. The target resource may correspond to, for example, at least one of a system, a device, and a vehicle related to a connected car service, and the system may include a plurality of devices. As described above, the resource ID data may include pieces of information about an ID type, a service to which the target resource belongs, a subject related to the target resource, and a type of the target resource. In addition, the resource ID data may further include information about at least one of a model name of the target resource, a version of the target resource, and a CID of the target resource.

In operation 520, the DID management device may generate a DID for the target resource, based on the resource ID data in response to receiving the issuance request for the DID. In operation 530, the DID management device may store a DID document for the generated DID in a DID document storage (e.g., the DID document storage 480 of FIG. 4). In operation 540, the DID management device may provide the generated DID to the provider device.

In an embodiment, the DID management device may receive, from the provider device, a request for verification of the scope indicating the access rights of the target resource. In response to receiving the request for verification of the scope of the access rights, the DID management device may transmit, to the provider device, scope data including information about the scope of the access rights. When receiving the issuance request for the DID, the DID management device may further receive public key data and the scope data from the provider device. The DID document may include the information about the scope of the access rights.

In an embodiment, the DID management device may receive, from the provider device, the resource ID data, the public key data, and a registration request for the target resource. In response to receiving the registration request for the target resource, the DID management device may search for a DID document corresponding to the resource ID data among DID documents stored in the DID document storage. When the DID document corresponding to the resource ID data is searched for, the DID management device may register the target resource.

In an embodiment, when receiving an update request for the scope of the access rights of the target resource, the DID management device may update scope information of the access rights of the target resource in the DID document of the target resource stored in the DID document storage.

In an embodiment, the DID management device may receive, from a DM agent (e.g., the DM agent 410 of FIG. 4), the resource ID data for the target resource, the scope data of the access rights of the target resource, and an issuance request for a VC. In response to receiving the issuance request for the VC, the DID management device may search for the DID document corresponding to the resource ID data among the DID documents stored in the DID document storage. When the DID document corresponding to the resource ID data is searched for, the DID management device may issue the VC for each scope of the access rights of the target resource. The DID management device may transmit list data of the issued VC to the DM agent.

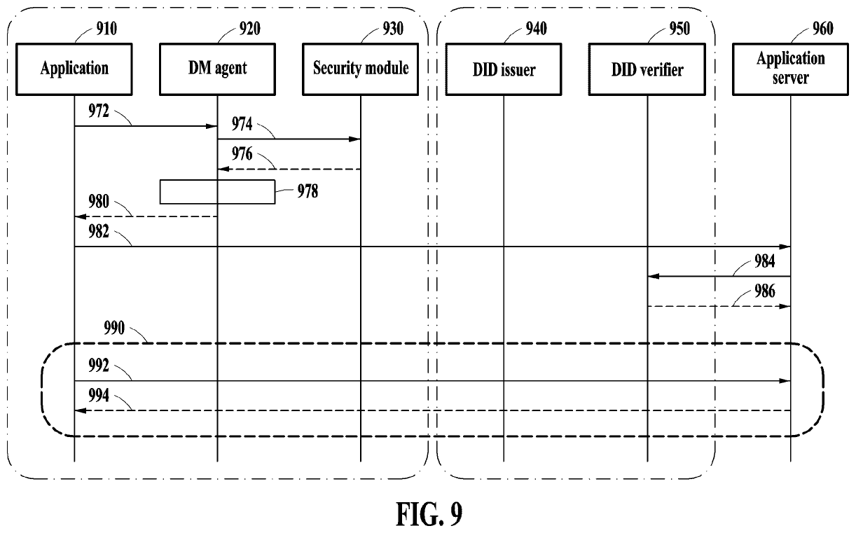

In an embodiment, the DM management device may receive, from an application server (e.g., an application server 960 of FIG. 9), VP data for an application and a verification request for the application. In response to receiving the verification request, the DID management device may perform verification based on the VP data. Thereafter, the DID management device may transmit, to the application server, verification result data for the application. The VP data may be generated by the DM agent, based on the generated VP for the application, signature data that signs the VC with a secret key, and the resource ID data for the target resource. The VP data may have a shorter expiration period than the VC.

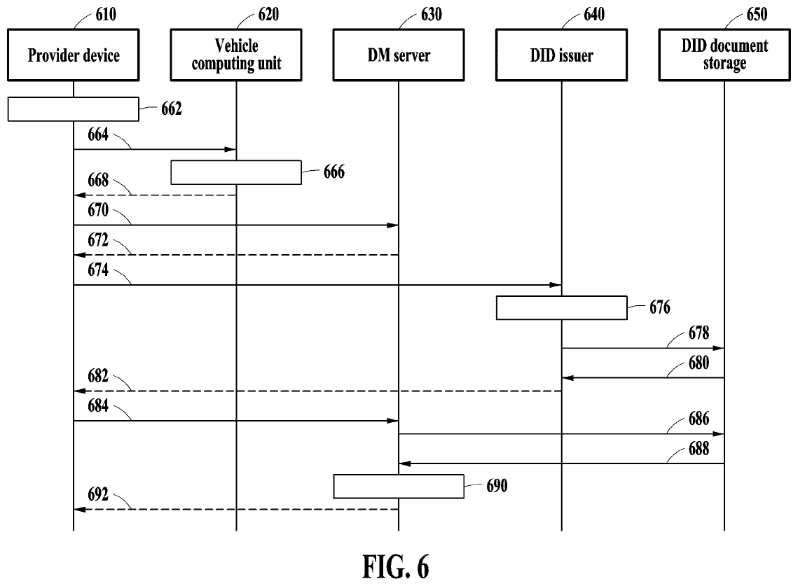

FIG. 6 is a diagram illustrating a provisioning process in a DID system, according to an embodiment.

In the provisioning process, a system may generate an asymmetric key pair to safely access a connected car service, store the generated asymmetric key pair in the system, and register the generated asymmetric key pair in a DM server. The provisioning process may include a process of generating the asymmetric key pair for identification and safely storing the generated asymmetric key pair, a process of issuing a DID, and a process of registering the system with the DM server. Each process is described in detail below with reference to the accompanying drawings.

Referring to FIG. 6, the process of generating the asymmetric key pair for identification and safely storing the generated asymmetric key pair may include the following operations. In operation 662, a provider device 610 may generate an asymmetric key pair (a public key, a private key (or a secret key)) to be used in the system. In operation 664, the provider device 610 may request to store the asymmetric key pair generated in operation 662 through an interface provided by a vehicle computing unit 620. In operation 666, the vehicle computing unit 620 may store the asymmetric key pair in an HSM (e.g., the HSM 460 of FIG. 4) which is a storage space that is physically impossible to steal. When the asymmetric key pair is completed to be stored, in operation 668, the vehicle computing unit 620 may transmit storage result information to the provider device 610.

The process of issuing the DID may include the following operations.

In operation 670, the provider device 610 may request a DM server 630 to arrange the scope, which is a list of rights that should be initially assigned. The scope, which is the list of rights, may define which endpoint the system may access. The endpoint may indicate the location of any server existing in a cloud system. In operation 672, the DM server 630 may transmit, to the provider device 610, information about the scope arrangement of the list of rights that should be initially assigned to a target resource in the system. In operation 674, the provider device 610 may request a DID issuer 640 to issue the DID. Here, the provider device 610 may transmit resource ID data, public key data, and the scope arrangement indicating the list of rights of the target resource together. In operation 676, the DID issuer 640 may proceed with the process of issuing the DID. The DID issuer 640 may issue the given resource ID data as the DID without any change. In operation 678, the DID issuer 640 may generate a DID document and store the DID document in a DID document storage 650. Here, the DID document storage 650 may store information about the scope arrangement indicating the list of the rights of the target resource together. In operation 680, after the DID document is stored in the DID document storage 650, the DID document storage 650 may transmit the storage result to the DID issuer 640. In operation 682, the DID issuer 640 that completes the issuance process may transmit the resource ID data, which is the issued DID, to the provider device 610.

The process of registering the system with the DM server may include the following operations.

In operation 684, the provider device 610 may request the DM server 630 to register the system. Here, the provider device 610 may transmit the resource ID data of the system and the public key, and the DM server 630 may store the resource ID data of the system and the public key transmitted from the provider device 610. In operation 686, the DM server 630 may request the DID document corresponding to the given resource ID data from the DID document storage 650 to verify whether the given resource ID data is issued as an authenticable DID. In operation 688, the DID document storage 650 may transmit the DID document corresponding to the resource ID data to the DM server 630. In operation 690, the DM server 630 may proceed with the registration process of the system. In operation 692, the DM server 630 may transmit information about the registration result of the system to the provider device 610.

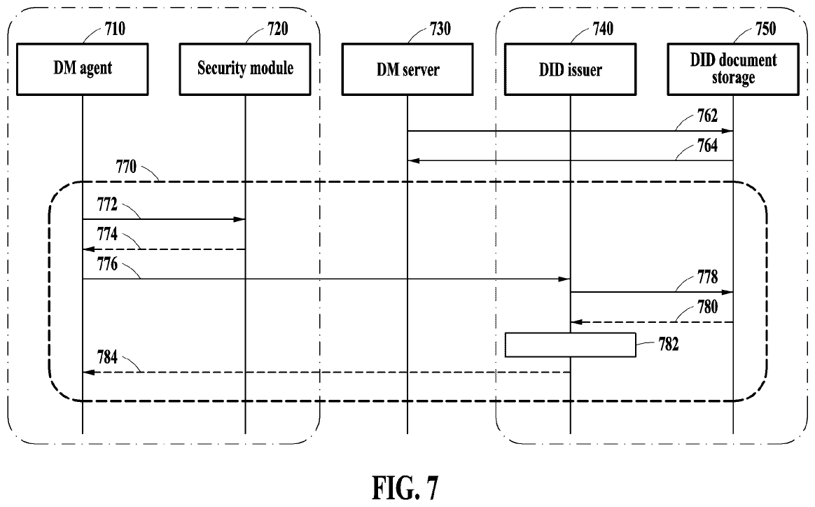

FIG. 7 is a diagram illustrating a process of issuing a VC, according to an embodiment.

In relation to the process of issuing the VC, a blockchain system of a DID system may be used for device authentication of a system. The process of issuing the VC may include a process of updating the scope indicating access rights of a target resource and a process of issuing the VC according to the scope indicating the access rights. The scope indicating the access rights of the target resource may include, for example, information about rights regarding which server the system may access. A DM server 730 may provide an API for handling the scope. The scope of the access rights of the target resource may be specified, for example, in a system model unit, and may be applied to all systems of a corresponding system model. In addition, it may be possible to specify the scope of the access rights of an individual system. The scope of the access rights of the system model and the scope of the access rights of the system may be provided by merging with each other, and when the scope of the access rights is the same, the scope of the access rights specified for the system may prioritize the scope of the access rights specified for the system model. The API for adding or deleting the scope of the access rights may be provided as a server API in the DM server 730. The DM server 730 may use a DID document storage 750 as a storage for storing the scope of the access rights and may manage a change history for the scope of the access rights through the DID document storage 750.

Each process is described in detail below with reference to the accompanying drawings.

Referring to FIG. 7, the process of updating the scope indicating the access rights of the target resource may include the following operations.

The DM server 730 may provide the API that may perform the functions of adding, modifying, and/or deleting the scope of the access rights of the target resource for any resource ID data. In operation 762, the DM server 730 may update such information to the DID document for the resource ID data stored in the DID document storage 750. In operation 764, the DID document storage 750 may update the DID document for the resource ID data and transmit information about the update result to the DM server 730. A DID issuer 740 and the DID document storage 750 may operate in a blockchain system.

The process of issuing the VC according to the scope indicating the access rights may include the following operations.

A DM agent 710 may receive the VC from the DID issuer 740. The VC may have an expiration period, and the DM agent 710 may periodically renew the VC before the expiration period. In operation 772, the DM agent 710 may sign the resource ID data and the contents of the list of the scope indicating the access rights of the target resource with a private key (or a secret key) of the system through a security module 720 (e.g., the HSM 460 of FIG. 4). In operation 774, the security module 720 may transmit the signature data signed with the private key of the system to the DM agent 710. The DM agent 710 and the security module 720 may be included in the system and operated.

In operation 776, the DM agent 710 may request the DID issuer 740 to issue the VC. When requesting the issuance of the VC, the DM agent 710 may transmit, to the DID issuer 740, the resource ID data for the system, the list of the scope of the access rights of the target resource, and the signature data obtained in the above operation. In operation 778, the DID issuer 740 may request the DID document corresponding to the resource ID data from the DID document storage 750 to verify whether the DM agent 710 actually has an access right for the requested scope of the access rights. In operation 780, the DID document storage 750 may transmit, to the DID issuer 740, the DID document corresponding to the resource ID data. In operation 782, the DID issuer 740 may issue the VC corresponding to each scope of the access rights of the target resource. Each scope may have an individual VC. In operation 784, the DID issuer 740 may transmit a list of issued VCs to the DM agent 710. A process 770 of operations 772 to 782 described above may be performed periodically by forming a loop.

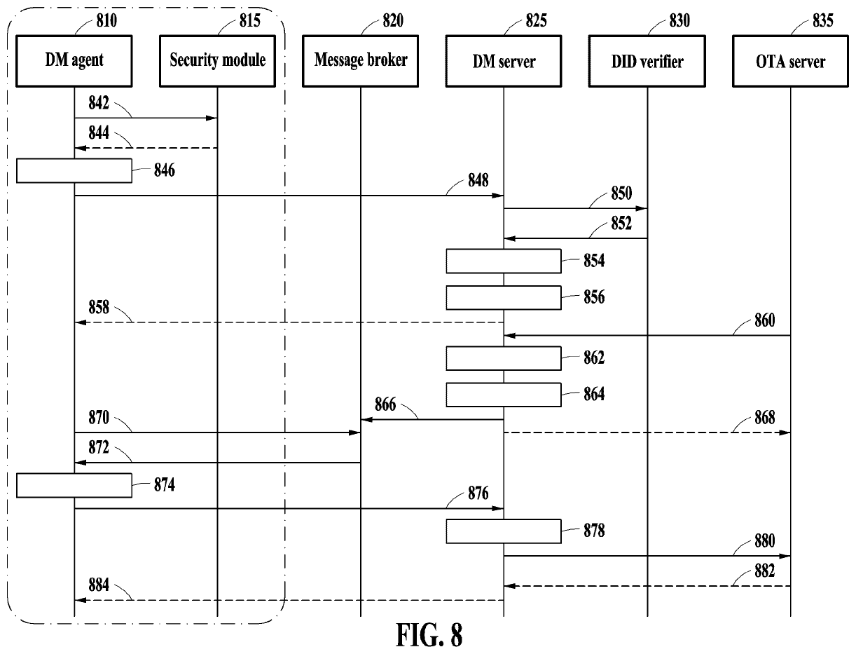

FIG. 8 is a diagram illustrating an example of authentication of a DM agent and use of an API, according to an embodiment.

ADM server 825 may provide an API that may be used in a DM agent 810. In the present disclosure, an authentication process of the DM agent 810 for secure communication and a use process of the API in relation to the API are described as examples of a part of over-the-air (OTA) update processes. The authentication process of the DM agent 810 may include the DM server 825 authenticating the DM agent 810 by receiving a Johnson web token (JWT) with a limited expiration period.

Referring to FIG. 8, the authentication process of the DM agent 810 may include the following operations.

In operation 842, the DM agent 810 may sign resource ID data of a system and a VC corresponding to the requested scope of access rights with a private key of the system using a security module 815 (e.g., the HSM 460 of FIG. 4). In operation 844, the security module 815 may transmit the signature data signed with the private key of the system to the DM agent 810. In operation 846, the DM agent 810 may generate VP data using the resource ID data of the system, the VC, and the signature data. The DM agent 810 and the security module 815 may be included in the system and operated.

In operation 848, the DM agent 810 may request authentication of the DM agent 810 while transmitting the VP data to the DM server 825. In operation 850, the DM server 825 may request verification of the VP data through a DID verifier 830. In operation 852, the DID verifier 830 may verify the VP data and transmit information about the verification result to the DM server 825. In operation 854, the DM server 825 may generate a token capable of authenticating the DM agent 810. In operation 856, the DM server 825 may sign the generated token with a private key (or a secret key) of the DM server 825 and finally generate a JWT. In operation 858, the DM server 825 may respond to the DM agent 810 using the generated JWT.

In an embodiment, the DM server 825 and the DM agent 810 may communicate with each other through the following push and pull functions.

The push function may be used to actively send a message to any system in the DM server 825. For example, when there is a system that needs to be updated during an OTA process, the push function may be used to announce this. When the push function is performed, a message may be sent from the DM server 825 to the DM agent 810. This message-sending process may be performed asynchronously and may be implemented in the form of publishing the message using a protocol such as message queue telemetry transport (MQTT) over mTLS.

In the case of a pull function, the DM agent 810 may be used to actively make a request to the DM server 825 or to respond to the message received through the push function. The pull function may be requested to the API provided by the DM server 825 in the direction from the DM agent 810 to the DM server 825. This process may be performed synchronously and implemented as a RESTful API, for example. A transport calling the API may be implemented by, for example, hypertext transfer protocol secure (HTTPS) over mTLS or constrained application protocol (CoAP) over quick UDP internet connections (QUIC) w/datagram transport layer security (DTLS), in which a client and a server mutually authenticate each other.

Using an alarm for OTA as an example, among the processes of the push function and the pull function described above, a process of pushing a message from the DM server 825 to the DM agent 810 is described as follows.

In operation 860, an OTA server 835 may call a push server API provided by the DM server 825 and transmit an update request message indicating that a certain system should perform an OTA update. In operation 862, the DM server 825 may sign the received update request message with a private key of the DM server 825. In operation 864, the DM server 825 may generate a message to be published as the update request message and signature data. In operation 866, the DM server 825 may publish the generated message to a message broker 820 to be transmitted. The message broker 820 may be a type of message queue platform, and the message queue platform may be implemented as an MQTT over mTLS protocol. The message broker 820 may play an intermediate role in sending a message received from a sender (e.g., the DM server 825) to a receiver (e.g., the DM agent 810) and enable messages to be exchanged between pieces of application software. A space where messages are loaded may be referred to as a message queue. In operation 868, the DM server 825 may respond to the OTA server 835 that the message is pushed.

In operation 870, the DM agent 810 may subscribe to the message broker 820 as resource ID data of the DM agent 810. In operation 872, the DM agent 810 may receive the message published by the DM server 825 through the message broker 820. In operation 874, the DM agent 810 may verify whether the message is a message generated by the DM server 825 by verifying the signature of the message with a public key of the DM server 825. In operation 876, the DM agent 810 may transmit a pull request provided to the API to the DM server 825 in response to the received update request message. Here, the DM agent 810 may transmit, to the DM server 825, a JWT generated during the authentication process of the DM agent 810, thereby enabling the DM server 825 to verify the identity of the DM agent 810.

In operation 878, the DM server 825 may verify the JWT received from the DM agent 810. In operation 880, the DM server 825 may transmit the JWT verification request to the OTA server 835 that may process an actual verification request for the JWT. In operation 882, the OTA server 835 may receive the JWT verification request, perform verification, and transmit information about the verification result to the DM server 825. In operation 884, the DM server 825 may transmit the information about the verification result received from the OTA server 85 to the DM agent 810.

FIG. 9 is a diagram illustrating an application authentication process according to an embodiment.

An application 910 in a system may use an authentication mechanism that uses a DID system of a blockchain system (or a blockchain platform) as an API provided by a DM service. A DM agent 920 may issue VP data in the DID system to the application 910. The application 910 may receive the VP data through the DM agent 920 for the scope indicating access rights to a certain server. The DM agent 920 may receive and manage a VC in advance to issue the VP data or may receive a VC when needed. The application 910 may transmit the VP data during a communication process to an application server 960, and the application server 960 may authenticate the application 910 by verifying the received VP data through a DID.

The application authentication process may include issuing the VP data having the scope indicating the access rights and establishing a secure channel using the VP data. Each process is described in detail below with reference to the accompanying drawings.

Referring to FIG. 9, the process of issuing the VP data having the scope indicating the access rights may include the following operations.

In operation 972, the application 910 may express a server to be accessed as the scope indicating the access rights and may request issuance of the VP data (or VP) while transmitting information about the scope to the DM agent 920. In operation 974, the DM agent 920 may sign resource ID data of the system and the VC corresponding to the requested scope of the access rights with a private key of the system using a security module 930 (e.g., the HSM 460 of FIG. 4). In operation 976, the security module 930 may transmit the signature data signed with the private key of the system to the DM agent 920. In operation 978, the DM agent 920 may generate the resource ID data of the system, the VC, and the VP data using the signature data. In operation 980, the DM agent 920 may transmit the generated VP data to the application 910. The VP data may have an expiration period, and the expiration period of the VP data may be relatively shorter than the VC. When the expiration date of the VP data expires, the application 910 may perform the operations described above and receive the VP data. The application 910, the DM agent 920, and the security module 930 may be included in the system and operated.

The process of establishing the secure channel using the VP data may include the following operations.

In operation 982, when the application 910 is connected to the application server 960, the VP data received from operation 980 may be transmitted to the application server 960. In operation 984, the application server 960 may request verification of the VP data received from a DID verifier 950. In operation 986, the DID verifier 950 may verify the VP data and transmit data about the verification result to the application server 960. The secure channel may be established using the VP data, and in operations 992 and 994, the application 910 and the application server 960 may communicate with each other through the established secure channel. A data packet may be transmitted and received between the application 910 and the application server 960 through the secure channel. A process 990 of operations 992 and 994 may be performed continuously by forming a loop. A DID issuer 940 and the DID verifier 950 may operate in a blockchain system.

FIG. 10 is a diagram illustrating a configuration of a DID management device for a DID system, according to an embodiment.

Referring to FIG. 10, a DID management device 1000 may be a device that performs a DID management method for a vehicle system described herein. The DID management device 1000 may include one or more processors 1010, a memory 1020, and a communication module 1030, and each component of the DID management device 1000 may communicate with each other via a communication bus 1040. In an embodiment, some of these components may be omitted from the DID management device 1000, or another component may be added to the DID management device 1000.

The one or more processors 1010 may control other components (e.g., hardware or software components) of the DID management device 1000 and may perform a variety of data processing or operations. According to an embodiment, as at least part of data processing or operations, the one or more processors 1010 may store instructions or data received from other components in the memory 1020, process the instructions or data stored in the memory 1020, and store result data in the memory 1020.

The one or more processors 1010 may include a main processor (e.g., a CPU or an AP) or an auxiliary processor (e.g., a GPU, an NPU, an ISP, a sensor hub processor, or a CP) that may operate independently or together with the main processor.

The memory 1020 may store a variety of data used by the components (e.g., the one or more processors 1010 or the communication module 1030) of the DID management device 1000. The data may include, for example, a program (e.g., an application), input data or output data for instructions related thereto, and log data of a computing system. The memory 1020 may store instructions executable by the one or more processors 1010. The memory 1020 may include a volatile memory or a non-volatile memory.

The communication module 1030 may support the establishment of a direct (e.g., wired) communication channel or a wireless communication channel between the DID management device 1000 and another device and may support the communication through the established communication channel. For example, the communication module 1030 may receive resource ID data generated according to a CRN scheme from a communication network or another device. The communication module 1030 may include a communication circuit to perform a communication function. The communication module 1030 may include a CP that operates independently from the one or more processors 1010 and supports direct (e.g., wired) or wireless communication. The communication module 1030 may include a wireless communication module (e.g., a Bluetooth communication module, a cellular communication module, a Wi-Fi communication module, or a GNSS communication module) that performs wireless communication or a wired communication module (e.g., a LAN communication module).

According to an embodiment, the DID management device 1000 may include the one or more processors 1010 and the communication module 1030 that receives, from a provider device, the resource ID data for identifying a target resource in a vehicle system and an issuance request for a DID of the target resource. In response to receiving the issuance request for the DID, the one or more processors 1010 may generate the DID for the target resource, based on the resource ID data. The one or more processors 1010 may store a DID document for the generated DID in a DID document storage (e.g., the DID document storage 480 of FIG. 4). The one or more processors 1010 may control the communication module 1030 to provide the generated DID to the provider device.

In an embodiment, the communication module 1030 may receive, from the provider device, the resource ID data, public key data, and a registration request for the target resource. In response to receiving the registration request for the target resource, the one or more processors 1010 may search for a DID document corresponding to the resource ID data among the DID documents stored in the DID document storage. When the DID document corresponding to the resource ID data is searched for, the one or more processors 1010 may register the target resource.

In an embodiment, the communication module 1030 may receive, from a DM agent (e.g., the DM agent 410 of FIG. 4), the resource ID data for the target resource, scope data of access rights of the target resource, and an issuance request for a VC. In response to receiving the issuance request for the VC, the one or more processors 1010 may search for the DID document corresponding to the resource ID data among the DID documents stored in the DID document storage. When the DID document corresponding to the resource ID data is searched for, the one or more processors 1010 may issue the VC for each scope of the target resource.

In an embodiment, the communication module 1030 may receive, from an application server (e.g., the application server 960 of FIG. 9), VP data for an application and a verification request for the application. In response to receiving the verification request for the application, the one or more processors 1010 may perform verification based on the VP data. The one or more processors 1010 may control the communication module 1030 to transmit verification result data about the application to the application server.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The devices described above may be configured to act as one or more software modules in order to perform the operations of the embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A resource identification method for a connected car service, the resource identification method comprising:
receiving resource identifier (ID) data associated with the connected car service; and
identifying a target resource corresponding to the resource ID data by parsing the received resource ID data,
wherein the resource ID data comprises pieces of information about an ID type, a service to which the target resource belongs, a subject related to the target resource, and a type of the target resource.

2. The resource identification method of claim 1, wherein the information about the ID type comprised in the resource ID data indicates whether an ID for identifying the target resource is a canonical ID (CID) used in an individual system or a decentralized ID (DID) generated in a decentralized vehicle identity system.

3. The resource identification method of claim 1, wherein the information about the subject related to the target resource comprised in the resource ID data indicates a provider or an owner of the target resource.

4. The resource identification method of claim 1, wherein the information about the type of the target resource comprised in the resource ID data indicates the type of the target resource defined in the service to which the target resource belongs.

5. The resource identification method of claim 1, wherein the resource ID data further comprises information about a model name of the target resource.

6. The resource identification method of claim 1, wherein the resource ID data further comprises information about a version of the target resource.

7. The resource identification method of claim 1, wherein the resource ID data further comprises information about a CID of the target resource.

8. The resource identification method of claim 1, wherein, in the resource ID data, the pieces of information about the ID type, the service to which the target resource belongs, the subject related to the target resource, and the type of the target resource are distinguished from each other by a delimiter.

9. The resource identification method of claim 8, wherein the resource ID data comprises one or more delimiters located at an end portion of the resource ID data.

10. The resource identification method of claim 1, wherein the target resource corresponds to at least one of a system, a device, and a vehicle associated with the connected car service,
wherein the system comprises a plurality of devices.

11. A non-transitory computer-readable storage medium storing instructions that, when executed by a processor, cause the processor to perform the resource identification method of claim 1.

12. A resource identification apparatus for a connected car service, the resource identification apparatus comprising:
one or more processors; and
a memory configured to store computer-executable instructions,
wherein, the computer-executable instructions, when executed by the one or more processors, cause the one or more processors to:
receive resource identifier (ID) data associated with the connected car service; and
identify a target resource corresponding to the resource ID data by parsing the received resource ID data,
wherein the resource ID data comprises pieces of information about an ID type, a service to which the target resource belongs, a subject related to the target resource, and a type of the target resource.

13. The resource identification apparatus of claim 12, wherein the information about the ID type comprised in the resource ID data indicates whether an ID for identifying the target resource is a canonical ID (CID) used in an individual system or a decentralized ID (DID) generated in a decentralized vehicle identity system.

14. The resource identification apparatus of claim 12, wherein the information about the subject related to the target resource comprised in the resource ID data indicates a provider or an owner of the target resource.

15. The resource identification apparatus of claim 12, wherein the information about the type of the target resource comprised in the resource ID data indicates the type of the target resource defined in the service to which the target resource belongs.

16. The resource identification apparatus of claim 12, wherein the resource ID data further comprises information about a model name of the target resource.

17. The resource identification apparatus of claim 12, wherein the resource ID data further comprises information about a version of the target resource.

18. The resource identification apparatus of claim 12, wherein the resource ID data further comprises information about a CID of the target resource.
